(19) United States
(12) Patent Application Publication
(10) Pub. No.: US 2014/0007078 A1
(43) Pub. Date: Jan. 2, 2014

(54) PERSONAL COMPUTER SYSTEM WITH COMPARTMENT FOR LONG-TERM STORAGE OF ASSOCIATED OBJECT AND METHODS

(71) Applicant: Gregory Theodosios Kavounas, Bellevue, WA (US)

(72) Inventor: Gregory Theodosios Kavounas, Bellevue, WA (US)

(21) Appl. No.: 13/974,304

(22) Filed: Aug. 23, 2013

Related U.S. Application Data
(60) Provisional application No. 61/771,826, filed on Mar. 2, 2013.

(51) Int. Cl. G06F 1/16; G06F 9/44

(52) U.S. Cl. CPC G06F 1/16; G06F 8/00
USPC 717/174; 361/679.6; 361/679.4

(57) ABSTRACT

A personal computer system (“PC”) is provided with a housing that includes a storage compartment. One or more objects associated with the PC can be stored in the storage compartment, such as a user manual, a warranty card, a memory device that stores as software package downloaded to the a card or other object showing a software product key code, and so on, Such objects are more reliably retrieved, when time comes for a service call about the PC, or receiving a discount for an upgrade. This may be helpful for users of PCs, for Information Technology (IT) departments that manage PCs for other users, for data centers, and so on.

CROSS REFERENCE TO RELATED PATENT APPLICATIONS

This patent application claims priority from U.S. Provisional Patent Application Ser. No. 61/771,826, filed on Mar. 2, 2013, titled: “PERSONAL COMPUTER WITH STORAGE COMPARTMENT”, the disclosure of which is hereby incorporated by reference for all purposes.

### BACKGROUND

Personal computer systems (“PCs”) are widely known and used in homes, places of work, data centers, etc. A sample PC in the prior art is now described,

Referring to FIG. 1, components of a conventional personal computer system are described. The components include a housing 110, which contains at least a processor 120, such as a microprocessor. A memory 122 is also typically provided in housing 110. Memory 122 may store programs for execution by processor 120. A reboot switch 130 is typically also provided on housing 110, which may be used to restart processor 120 manually.

Moreover, a port 140 may be coupled to housing 110. Port 140 may be intended for use during the regular operation of the PC. Port 140 may be a USB port, a CD ROM drive, a DVD drive, a plug for plugging in an accessory for the personal computer system, a cable port, and so on. Port 140 may receive an other device 142 according to an arrow 144. When other device 142 is so received, port 140 enables other device 142 to exchange data with processor 120 via port 140. Other device 142 may be a thumb drive, a CD ROM with a software product, a DVD with a product, a cable, etc. PCs are typically additionally provided with more ports, a screen, a keyboard, speakers, a power cord, etc.

PCs are further provided with a number of additional associated objects, such as object 150. Object 150 is associated with other components of the PC, as indicated by arrow 151. Object 150 might be of the type that is used rarely, such as an instruction manual, a warranty card, one or more memory devices that store software products that are stored in memory 122, cards showing product key codes, and so on. Object 150 may be provided by the manufacturer, or be purchased later. And, in some embodiments, object 150 may operate as other device 142.

A problem is that, after installation of the PC, associated objects such as object 150 often become stored elsewhere, and then forgotten about. If, however, years later, the owner is to make a service call, these objects become necessary. Those responding to the service call may first ask for these objects and for the product code numbers they indicate, so as to prove ownership of the software products in the PC. They may also need the memory device to reinstall its software product.

### BRIEF SUMMARY

The present description gives instances of personal computer systems and methods, the use of which may help overcome problems and limitations of the prior art.

In one embodiment, a personal computer system (“PC”) is provided with a housing that includes a storage compartment. One or more objects associated with the PC can be stored in the storage compartment, such as a user manual, a warranty card, a memory device that stores a software package downloaded to the PC, a card or other object showing a software product key code, and so on.

An advantage over the prior art is that such objects are more reliably retrieved, when time comes for a service call about the PC, or receiving a discount for an upgrade. This may be helpful for users of PCs, for Information Technology (IT) departments that manage PCs for other users, for data centers, and so on.

These and other features and advantages of this description will become more readily apparent from the following Detailed Description, which proceeds with reference to the drawings, in which:

### BRIEF DESCRIPTION OF THE DRAWINGS

FIG. 1 is a diagram of components of a conventional personal computer system.

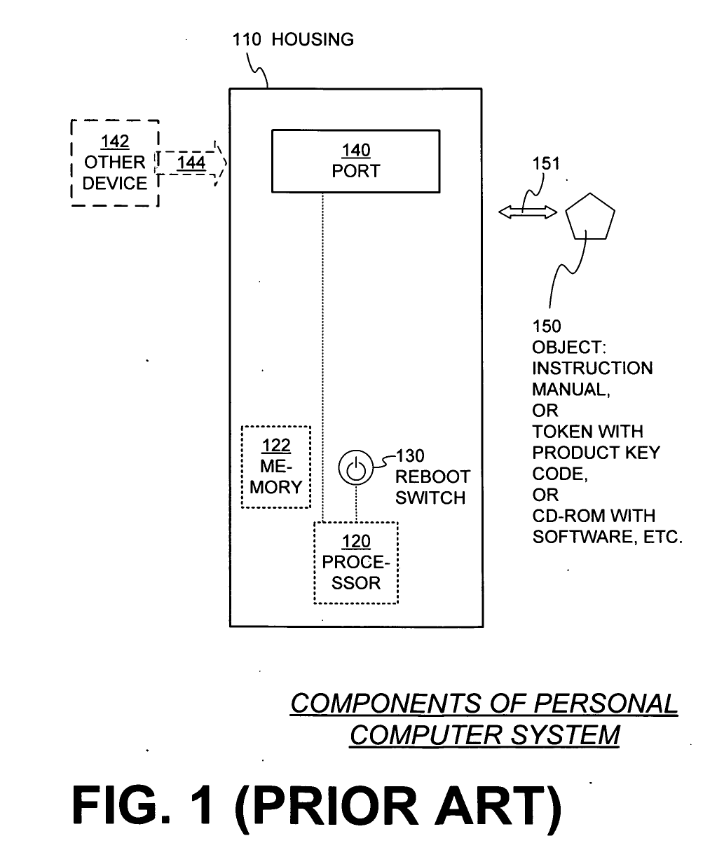

FIG. 2 is a diagram of components of a personal computer system made according to embodiments of the invention.

FIG. 3 is a diagram of components of a personal computer system, according to embodiments in which the main storage compartment is provided at the top of the housing, and with an optional door.

FIG. 4 is a diagram of components of a personal computer system, according to embodiments in which the compartment is provided at a side wall of the housing, and with an optional door.

FIGS. 5A and 5B are diagrams of components of a personal computer system according to embodiments, showing respectively the compartment door open and closed.

FIG. 6 is a flowchart for illustrating methods according to embodiments.

### DETAILED DESCRIPTION

As has been mentioned, the present description is about personal computer systems. Embodiments are now described in more detail.

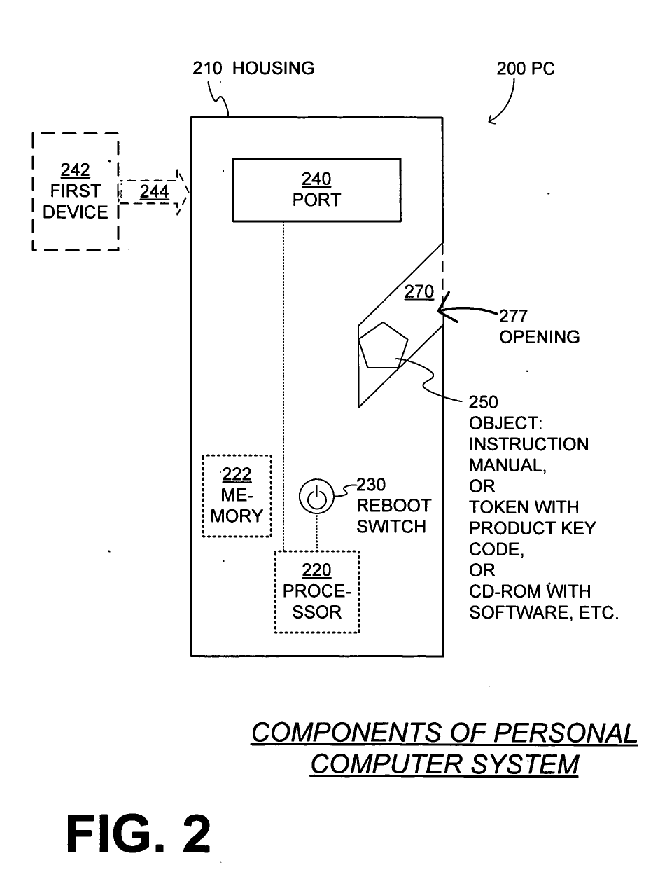

FIG. 2 is a diagram of components of a personal computer system (PC) 200, which is made according to embodiments of the invention. PC 200 includes a housing 210, which contains at least a processor 220, such as a microprocessor. A memory 222 is also typically provided in housing 210. Memory 222 may store programs for execution by processor 220. A reboot switch 230 is typically also provided on housing 210, which may be used to restart processor 220 manually. Reboot switch 230 can also be a power-on switch.

Moreover, a port 240 may be coupled to housing 210. Port 240 may be intended for use during the regular operation of the PC. Port 240 may be a USS port, a CD ROM drive, a DVD drive, a plug for plugging in an accessory for the PC, a cable port, and so on. Port 240 may receive a first device 242 according to arrow 244. When first device 242 is so received, port 240 enables first device 242 to exchange data with processor 220 via port 240. Other device 242 may be a thumb drive, a CD ROM with a software product, a DVD with a product, a cable, etc. PC 200 may be further provided with more ports, a screen, a keyboard, speakers, a power cord, etc.

PC 200 is further provided with at least one associated object 250. Object 250 may be provided by the manufacturer, or be purchased later. And, in some embodiments, object 250 could be first device 242. Object 250 might be of the type that is used rarely, such as an instruction manual for the use of PC 200, a warranty card, one or more memory devices that store software products that are stored in memory 222, cards showing product key codes, and so on. In case object 250 is associated with software, the software could be the operating system that PC 200 is sold with or other software that is added on at purchasing time, or later. If object 250 is an instruction manual, then it could be a booklet or folded paper. If object 250 is a warranty card, then it could be a postcard. Object 250 is shown in the general shape of a pentagon, to indicate that it could have the shape of any one of these embodiments.

In some embodiments, a software product is stored in memory 222, and object 250 is associated with the software product, such as an operating system, an application, and so on. For example, object 250 can have printed on it a key code for downloading the software product to the personal computer system, or enabling it to be run indefinitely. Object 250 can be a CD-ROM, a DVD, a box for a CD-ROM or a DVD, a postcard, and so on. In some embodiments, object 250 may operate as first device 242.

Housing 210 also includes an opening 277. More particularly, in the example of FIG. 2, housing 210 generally defines a plane at that location, and opening 277 is an opening at that location, and within that plane. A different example will be described later.

Moreover, housing 210 includes a main storage compartment 270. Compartment 270 may be accessible from outside housing 210 via opening 277. Compartment 270 may be used for storing object 250 removably, which means that object 250 may be stored in compartment 270, and then removed from there. As such, object 250 can be retained in compartment 270, together with PC 200, for the long term, until it is needed for a service call.

In some embodiments, object 250 is stored within main storage compartment 270. For example, that is where a user or IT department may store object 250. In other embodiments, object 270 may be shipped to a reseller or a customer in a box along with housing 210, but not within compartment 270. It could be up to the user to store object 250 in compartment 270.

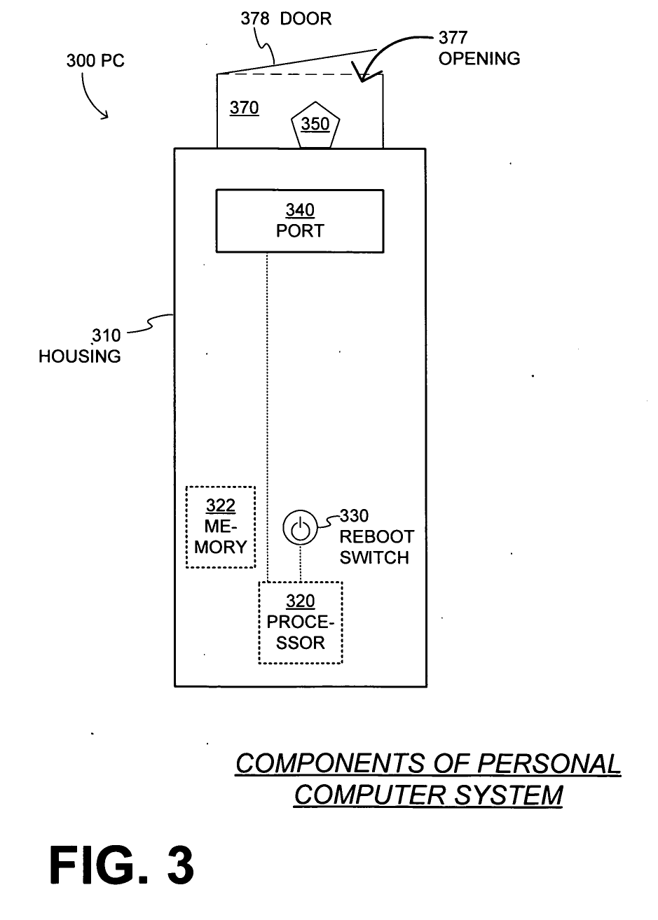

In FIG. 3, main storage compartment 270 is of a generic shape, to indicate that main storage compartment 270 could have any shape. In preferred embodiments, care is taken to give main storage compartment 270 a shape that is suitable for receiving and storing object 250. As such, the shape of compartment 270 may be determined by the shape of object 250, which is often substantially flat. Another consideration is for main storage compartment 270 to have a shape that does not interfere with other components inside housing 210, or with the airflow of a fan that could be cooling processor 220.

In some embodiments, object 250 measures at least 2″ (5 cm) in a width dimension, by at least 2′ (5 cm) in a height dimension, by at least 0.04″ (0.1 cm) in a depth dimension. In addition, main storage compartment 270 may be shaped and large enough so that object 250 can be stored therein without being bent, and without protruding through opening 277.

Another consideration is to decide on which wall of housing 210 to place opening 277. It should be considered that object 250 is typically thin and flat and, as such, a large surface may be sought in which to create opening 277. In some embodiments, the housing includes a wall that stands vertically when the PC is operated, and the opening is at the wall. This is suitable for embodiments such as that of FIG. 2, where housing 210 is in the upright “tower” configuration, and the vertical walls are large. That need not be always the case, however. Another example is now described.

FIG. 3 is a diagram of components of a personal computer system 300, which is made according to embodiments. PC 300 includes a housing 310, which contains at least a processor 320 similar to processor 220. A memory 322 is provided in housing 310, and a reboot switch 330 is provided on housing 310, similar to reboot switch 230. A port 340, similar to port 240, may be coupled to housing 310, In addition, PC 300 is provided with at least one object 350 similar to object 250.

Moreover, housing 310 includes a main storage compartment 370. Compartment 370 may be accessible from outside housing 310 via opening 377. Compartment 370 may be used for storing object 350 removably, in the example of FIG. 3, object 350 is shown stored in main storage compartment 370.

In the example of FIG. 3, main storage compartment 370 is at the top of housing 310. Housing 310 includes an opening 377, which is also an opening of compartment 370. Unlike the example of FIG. 2, however, opening 377 is not an opening within a larger plane of housing 310.

Optionally, in a PC made according to embodiments, the housing further includes a door for the main storage compartment. In the example of FIG. 3, housing 310 includes a door 378 that opens upwards. Door 378 is implemented so that it can be opened to substantially permit access to main storage compartment 370 via opening 377, and closed to substantially limit access to main storage compartment 370 via opening 377. When closed, access may be limited completely, or only partially. If partially, for example, the door may leave a slit through which materials can be inserted in compartment 370, but not easily removed without opening door 378. Door 378 may have further a handle for being opened and closed.

In this example, door 378 is supported on a hinge, and opens and closes by rotating around the hinge. Other embodiments can also be implemented. For example, the door could open and dose by sliding. The door can be made from any suitable material, such as the material used for housing 310. Alternately the door could be transparent, from plastic, and so on. Making the door able to slide may present concerns as to its structural integrity, but it maybe preferred if not enough space is expected to be provided between PCs, for opening a door by swinging it on a hinge.

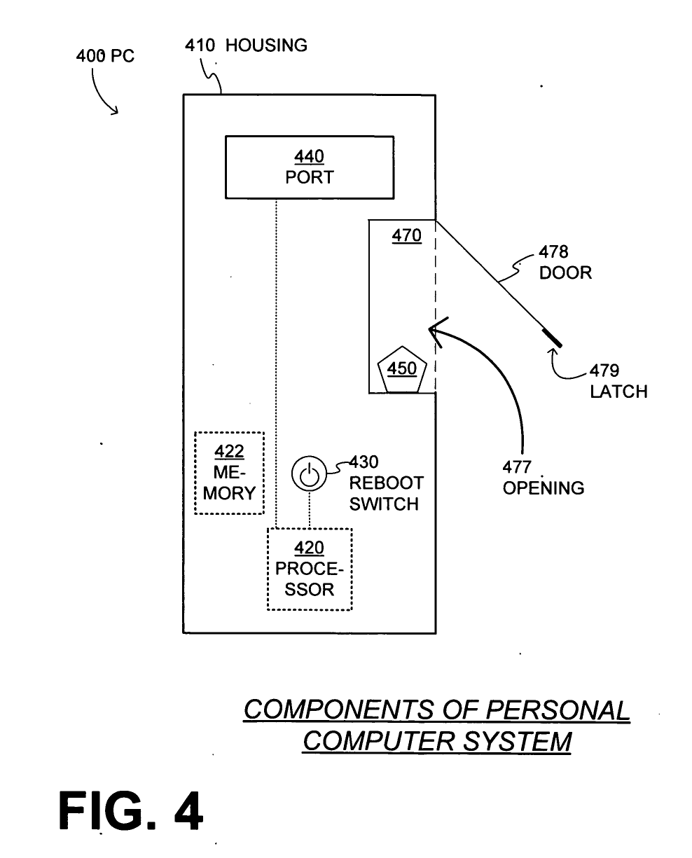

FIG. 4 is a diagram of components of a personal computer system 400, which is made according to embodiments. PC 400 includes a housing 410, which contains at least a processor 420 similar to processor 220. A memory 422 is provided in housing 420, and a reboot switch 430 is provided on housing 410, similar to reboot switch 230. A port 440, similar to port 240, may be coupled to housing 410. In addition PC 400 is provided with at least one object 450 similar to object 250.

Moreover, housing 410 includes a main storage compartment 470. Compartment 470 may be accessible from outside housing 410 via opening 477.

Compartment 470 may be used for storing object 450 removably. In the example of FIG. 4 object 450 is shown stored in main storage compartment 470.

In the example of FIG. 4, storage compartment 470 is at a vertical side wall of housing 410. An opening 477 is an opening of housing 410, and also of compartment 470. Moreover, a door 478 is optionally provided which, in this example, opens upwards. Door 478 may have further a handle for being opened and closed.

Furthermore, in the embodiment of FIG. 4, door 478 include a latch 479, for remaining closed. Since a latch can be opened by anyone, embodiments with a latch are useful in environments where trust is high, such as within a home or a data center and, worrying about a key is more of a problem and a liability than a benefit.

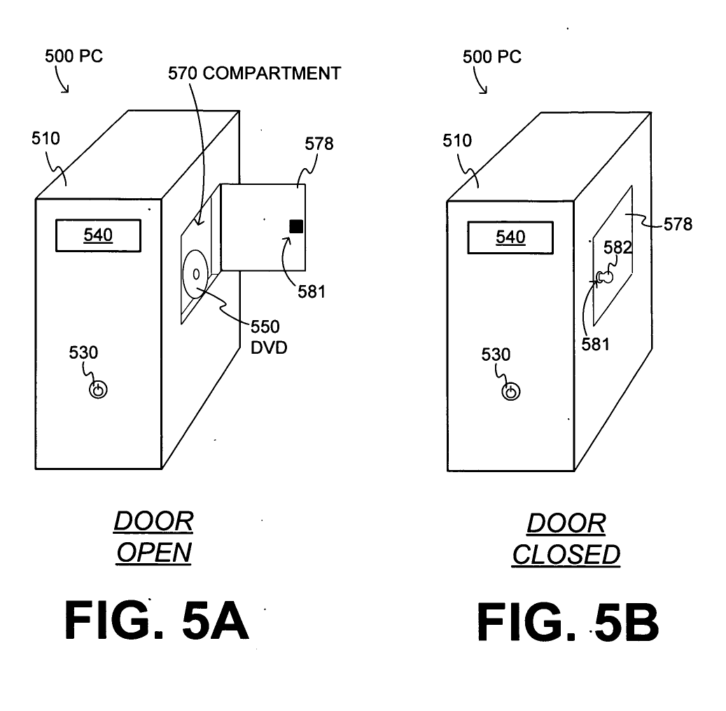

FIGS. 5A and 5B are diagrams of components of a personal computer system 500, which is made according to embodiments. PC 500 includes a housing 510, which contains at least a processor and a memory (not shown). A reboot switch 530 is provided on housing 510, similar to reboot switch 230. A port 540, similar to port 240, may be coupled to housing 510.

Referring particularly to FIG. 5A, a door 578 is open which permits access to main storage compartment 570. PC 500 is provided with a DVD 550, which stores software that is also stored on the processor of PC 500. As such, DVD 550 could be an embodiment of objects 250, 350, 450 described above. DVD 550 is stored in compartment 570. Additionally, door 578 optionally includes a lock 581.

Referring to FIG. 5B, door 578 is closed, which limits access to compartment 570. In the example of FIGS. 5A and 5B, lock 581 can be unlocked by a key 582, which is visible only in FIG. 5B. Key 582 may be retained by the user, or by a company's IT department. When key 582 is provided, it may avoid the need for door 578 to have a handle.

It will be observed that key 562 protrudes from the basic plane of housing 510. In some embodiments, the housing includes an auxiliary storage compartment that is distinct from the main storage compartment. The auxiliary storage compartment is accessible from outside the housing, and the key can be stored in the auxiliary storage compartment. This way, the key will not protrude. Again, in environments with trust is high, the key might never be used.

Keys according to embodiments need not be physical keys like key 582. For example, a PC typically receives electrical power from a power outlet at the housing, for its operational needs. In some embodiments, the housing includes a keypad that is powered by the received electrical power. In such embodiments, the lock can be unlocked by dialing a code in the keypad.

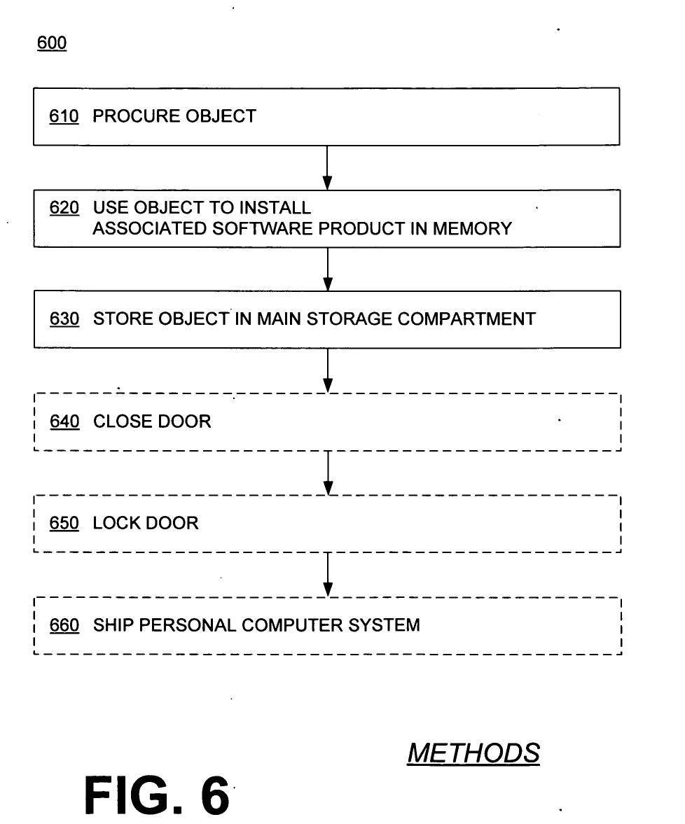

FIG. 6 shows a flowchart 600 for describing methods according to embodiments. The methods of flowchart 600 may also be practiced by using embodiments described above. For example what can be used is a personal computer system that includes a housing that has an opening and a main storage compartment that is accessible from outside the housing via the opening, and a memory within the housing. A number of operations of flowchart 600 were already described above.

According to an operation 610, an object can be procured, which is associated with a software product.

According to another operation 620, the object can be used to install the software product in the memory. For example, the personal computer system could further include a port, the object could include a memory device on which the software product is stored, and the software could be installed by inserting the memory device in the port. For another example, the object could have a product key code written thereon, and the software product could be installed by accessing a communications network via an interface, and entering the product key code in the interface. The communications network could include the internet.

According to one more operation 630, the object can be stored in the main storage compartment.

According to an optional operation 640, in embodiments where the housing also includes a door, the door is closed while the object is stored in the main storage compartment. Closing the door substantially limits access to the main storage compartment. In some embodiments, the door includes a latch and, once closed, the door is maintained closed due to the latch. Later, the door may be reopened, and the object may be removed from the main storage compartment.

According to an optional operation 650 occurring after operation 640, the door is locked after being closed. The door may later be unlocked. If locking is performed by a key, the housing could also include an auxiliary storage compartment, and the key could be stored in the auxiliary storage compartment.

According to an optional next operation 660, the personal computer system is then shipped to a reseller or to a customer.

In the above, the order of operations is not constrained to what is shown, and different orders may be possible according to different embodiments. In addition, in certain embodiments, new operations may be added, or individual operations may be modified or deleted.

This description includes one or more examples, but that does not limit how the invention may be practiced. Indeed, examples or embodiments of the invention may be practiced according to what is described, or yet differently, and also in conjunction with other present or future technologies.

A person skilled in the art will be able to practice the present invention in view of this description, which is to be taken as a whole. Details have been included to provide a thorough understanding. In other instances, well-known aspects have not been described, in order to not obscure unnecessarily the present invention.

Other embodiments include combinations and sub-combinations of features described herein, including for example, embodiments that are equivalent to: providing or applying a feature in a different order than in a described embodiment, extracting an individual feature from one embodiment and inserting such feature into another embodiment; removing one or more features from an embodiment; or both removing a feature from an embodiment and adding a feature extracted from another embodiment, while providing the advantages of the features incorporated in such combinations and sub-combinations.

The following claims define certain combinations and subcombinations of elements, features and steps or operations, which are regarded as novel and non-obvious. Additional claims for other such combinations and subcombinations may be presented in this or a related document.

What is claimed:

1. A personal computer system suitable for storing an object associated with the personal computer system, the object measuring at least 2″ (5 cm) in a width dimension, by at least 2″ (5 cm) in a height dimension, by at least 0.04″ (0.1 cm) in a depth dimension the personal computer system comprising:
a housing that includes an opening and a main storage compartment accessible from outside the housing via the opening, the main storage compartment shaped and large enough so that the object can be removably stored therein without being bent, and without protruding through the opening;
a processor within the housing; and
a reboot switch on the housing for rebooting the processor.

2. The personal computer system of claim 1, in which
the object is one of a booklet, folded paper, and a postcard.

3. The personal computer system of claim 1, further comprising:
a memory within the housing, and in which
a software product is stored in the memory, and
the object is associated with the software product.

4. The personal computer system of claim 3, further comprising:
a port coupled to the housing, the port configured to receive a first device so as to enable the first device to exchange data with the processor via the port, and in which the object operates as the first device.

5. The personal computer system of claim 1, in which
the object is stored within the main storage compartment.

6. The personal computer system of claim 1, in which
the housing includes a wall that stands vertically when the personal computer system is operated, and
the opening is at the wall.

7. The personal computer system of claim 1, in which
the housing further includes a door implemented so that it can be unlocked to substantially permit access to the main storage compartment via the opening, and closed to substantially limit access to the main storage compartment via the opening.

8. The personal computer system of claim 7, in which
the door includes a latch for remaining closed.

9. The personal computer system of claim 7, in which
the door includes a lock.

10. The personal computer system of claim 9, in which
the lock can be unlocked by a key.

11. The personal computer system of claim 10, in which
the housing also includes an auxiliary storage compartment that is distinct from the main storage compartment, the auxiliary storage compartment accessible from outside the housing, and
the key is stored in the auxiliary storage compartment.

12. The personal computer system of claim 9, in which
the housing receives electrical power from an outlet,
the housing includes a keypad that is powered by the received electrical power, and
the lock can be unlocked by dialing a code in the keypad.

13. A method for using a personal computer system that includes a housing that has an opening and a main storage compartment that is accessible from outside the housing via the opening, a memory within the housing, the method comprising:
procuring an object that is associated with a software product;
using the object to install the software product in the memory; and
storing the object in the main storage compartment.

14. The method of claim 13, in which
the personal computer system further includes a port,
the object includes a memory device on which the software product is stored, and
the software is installed by inserting the memory device in the port.

15. The method of dam 13, in which
the object has a product key code written thereon, and
the software product is installed by accessing a communications network via an interface, and entering the product key code in the interface.

16. The method of claim 13, in which
the housing also includes a door, and
further comprising: dosing the door while the object is stored in the main storage compartment, so as to substantially limit access to the main storage compartment.

17. The method of claim 16, in which
the door includes a latch, and
once closed, the door is maintained closed due to the latch.

18. The method of claim 16, further comprising
reopening the door; and
removing the object from the main storage compartment.

19. The method of claim 16, further comprising:
locking the door after closing it.

20. The method of claim 19 further comprising:
unlocking the door.

21. The method of claim 19, in which
locking is performed by a key,
the housing also includes an auxiliary storage compartment, and
the key is stored in the auxiliary storage compartment.

22. The method of claim 13, further comprising:
shipping the personal computer system to a reseller or to a customer.
